(19) United States
(12) Patent Application Publication
(10) Pub. No.: US 2014/0059108 A1
(43) Pub. Date: Feb. 27, 2014

(54) UNIFIED COMMUNICATION INTERFACE FOR DISTRIBUTED COMPUTING

(71) Applicants: Ronen Borshack, Ginaton (IL); Leonid Verny, Kiryat Ono (IL); Yael Flashner, Ness Ziona (IL)

(72) Inventors: Ronen Borshack, Ginaton (IL); Leonid Verny, Kiryat Ono (IL); Yael Flashner, Ness Ziona (IL)

(73) Assignee: MICROSOFT CORPORATION, Redmond, WA (US)

(21) Appl. No.: 13/595,044

(22) Filed: Aug. 27, 2012

(51) Int. Cl. G06F 15/16

(52) U.S. Cl. 709/201

(57) ABSTRACT

Implementing a unified communication system allowing different clients to communicate using different communication modalities to access the same functionality of a remote application. A method includes identifying functionality of an application of a service. The method further includes determining a plurality of communication modalities that can be used to access the functionality of the application of the service by identifying communication modalities identified by a developer as being communication modalities that can be used to access the functionality of the application of the service. The method further includes, based on identifying a plurality of communication modalities that can be used to access the functionality of the application of the service, determining that the functionality of the application is supported by a unified communication function. The method further includes at runtime mapping operation of the plurality of communication modalities to the unified communication function.

### BACKGROUND

### Background and Relevant Art

Computers and computing systems have affected nearly every aspect of modern living. Computers are generally involved in work, recreation, healthcare, transportation, entertainment, household management, etc.

Further, computing system functionality can be enhanced by a computing systems ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing system.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a set of web based services for communicating back and forth with clients. It may be desirable to use a given application with a plurality of different communication modalities to send and receive data between the remote application and clients using the remote application. For example, different applications may use different messaging and communication protocols, such as one or more of http, Windows Communication Foundation (WCF) available from Microsoft Corporation of Redmond Wash., Azure service bus available from Microsoft Corporation of Redmond Wash., etc. Often, different communication modalities may be used to try to access the same functionality in a remote application. The different communication modalities simply represent different ways of calling into and receiving messages from the remote application.

Most solutions today try to solve this need to support an ever increasing set of communication modalities by requiring application developers to write separate code modules for each communication modality to call into and receive messages from a given application. Thus, each different communication modality is handled by separate different code for a given application. This can increase the chance of introducing discrepancies in how each communication modality is handled in the actual application code and eventually may lead to a different and erroneous application behavior depending on which modality is selected by a client to access remote application functionality. Additionally, this may also include a significant effort on behalf of an application developer for handling all the different (and sometimes unique) aspects of each communication modality on their own.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced in a distributed computing environment. The method includes acts for implementing a unified communication system allowing different clients to communicate using different communication modalities to access the same functionality of a remote application. The method includes identifying functionality of an application of a service. The method further includes determining a plurality of communication modalities that can be used to access the functionality of the application of the service by identifying communication modalities identified by a developer as being communication modalities that can be used to access the functionality of the application of the service. The method further includes, based on identifying a plurality of communication modalities that can be used to access the functionality of the application of the service, determining that the functionality of the application is supported by a unified communication function. The unified communication function supports application functionality using different communication modalities. The method further includes at runtime mapping operation of the plurality of communication modalities to the unified communication function.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a remote service application;

FIG. 2 illustrates implementing unified communication for a remote application;

FIG. 3 illustrates code examples for annotating methods of a class; and

FIG. 4 illustrates a method of implementing a unified communication system.

### DETAILED DESCRIPTION

Embodiments may include functionality which allows an application developer the ability to simply describe what communication mechanisms are supported by a remote application. Further, the remote application developer can write a single set of code to provide application functionality, rather than writing a set of code for every communication modality supported by a given remote application. For example, a developer can simply use code decorations and code attributes to indicate which communication modalities are supported for a particular function of an application. This can be used so that a developer does not need to create a discrete code module for each communication modality as each communication modality is attempting to access the same functionality. As used herein, examples of communication modalities include various protocols, communication channels, and the like.

These code decoration and annotations can be used to create handlers for different communication modalities. Different handlers can intercept different service request messages using different modalities to request the same functionality implemented by the single set of code and execute the different requests against a service contract to access the functionality of the single set of code.

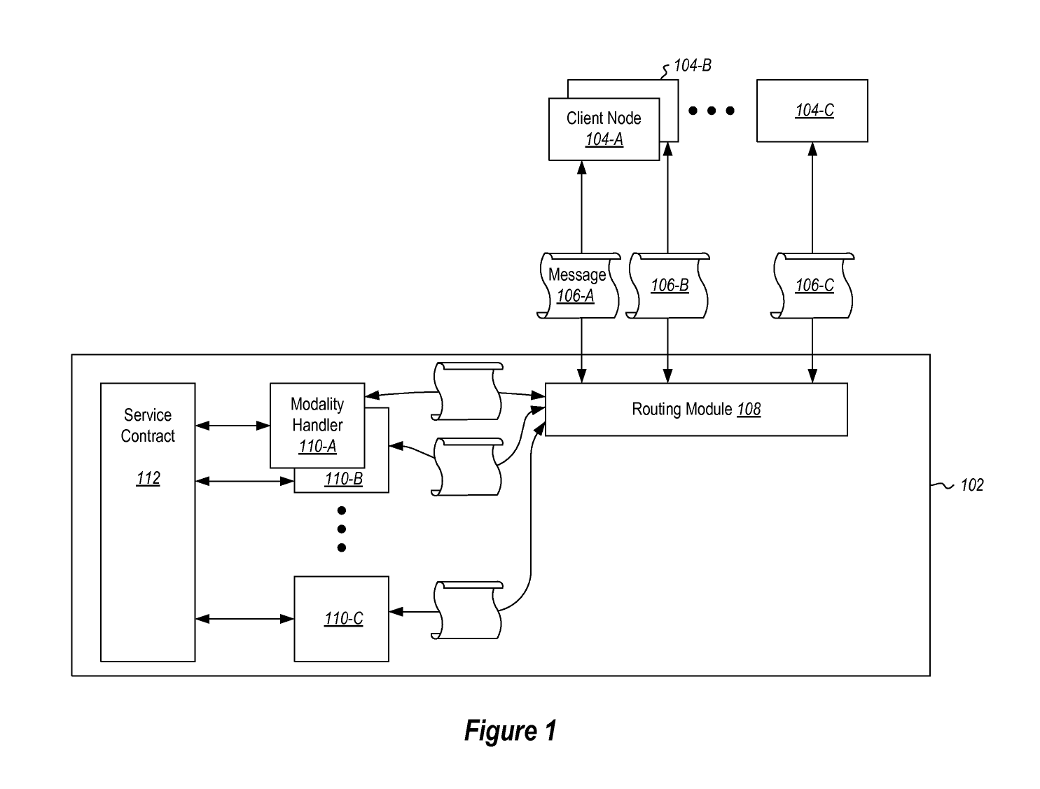

Referring now to FIG. 1, an example is illustrated. FIG. 1 illustrates a remote service application 102. The remote service application 102 may implement functionality desired to be accessed by a plurality of client nodes illustrated in the present example as 104-A 104B and 104-C. The ellipses illustrated indicate that any number of client nodes may be implemented. Each of the clients (referred to herein generally at 104) may communicate with the remote service application using one or more communication modalities. For example, FIG. 1 illustrates the client node 104-A communicating with the remote service application 102 using a service request message 106-A which is formed according to a first modality. Client node 104-B sends a service request message 106-B using a second modality. Client node 104-C sends a service request message 106-C using a third modality.

As illustrated in FIG. 1, the service request messages (referred to herein generally at 106) are intercepted by a routing module 108. The routing module 108 routes messages service request messages 106 to modality handlers based on the particular modality that a service request message is sent using and based on the modalities a particular handler is configured to handle. For example, FIG. 1 illustrates three modality handlers. Modality handler 110-A may be configured to handle service request messages sent using the first modality. Modality handler 110-B may be configured to handle service request messages sent using the second modality. Modality handler 110-C may be configured to handle service request messages sent using the third modality. Thus, the service request message 106-A is routed to the modality handler 110-A. The service request message 106-B is routed to the modality handler 110-B. The service request 106-C is routed to the modality handler 110-C.

Each of the modality handlers (illustrated herein generally at 110) includes functionality executing service request message 106 against a service contract 112. For example, the modality handlers 110 can invoke the single set of code to access functionality of the remote service application 102, and can do so based on having received a service request message 106 sent using an appropriate communication modality.

While FIG. 1 illustrates that a routing module may route service request messages 106 to the correct modality handler, in alternative embodiments, a service bus may be implemented. Each of the modality handlers 110 may listen on the service bus for messages appropriate to each given modality handler 110. A modality handler will then detect and handle any service request message 106 that is appropriate to the given modality handler 110 based on the modality of the service request message 106.

As noted above, embodiments may use attributes and decoration to define service communication end-points to transparently handle various communication modalities, such as different communication protocols. For example, embodiments may use .Net attributes and decoration to define service communication end-points to transparently handle various communication protocols like Windows Communication Foundation (WCF) and Azure service bus, all available from Microsoft Corporation of Redmond Wash. Embodiments may then generate messaging handlers, such as the modality handlers 110, automatically based on the declared supported communication protocols.

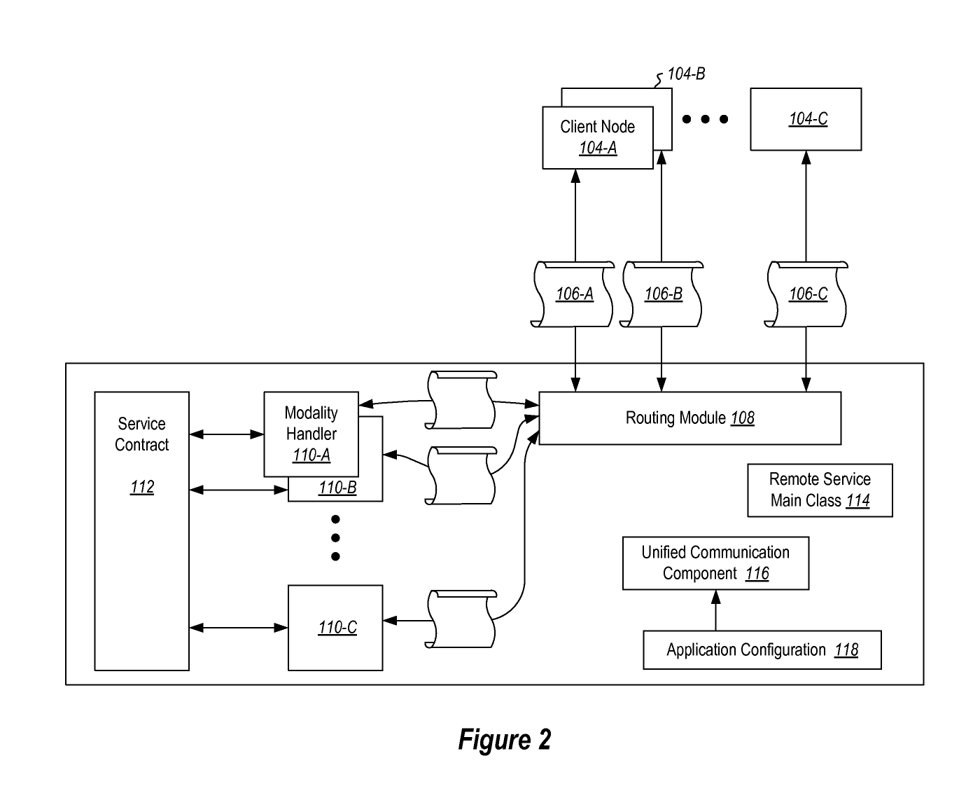

Additional details are now illustrated with reference to FIG. 2. In particular FIG. 2 illustrates functionality for implementing unified communication for remote or cloud services. In FIG. 2, a “Start” method of a remote service main class 114 may be invoked. This can be done to start-up or initialize a remote service framework or service. In the illustrated example, invoking the Start method invokes an “Initiate” method of a unified communication component 116 included as a part of the remote service application 102.

As part of the Initiate method, the unified communication component 116 checks an application configuration definition 118 to determine if a class is decorated with unified communication custom attributes. If so, the unified communication component 116 can read from the application configuration definition 118 the names of an interface defining the service contract 112 and a class that implements the service contract as an attribute's parameters. For example, in some embodiments, this may be accomplished using reflection, which is the ability in some computer program languages to examine and/or modify the structure of the application code itself at runtime.

The unified communication component 116 may obtain signatures of service contract methods and determine the communication modalities that various methods are designed to receive notifications. This may be done, in some embodiments, by reflection as well.

In accordance with decoration of service contract methods, the unified communication component 116 creates the modality handlers 110 and configures the routing module 108 to route to them. Alternatively the handlers 110 may be configured to listen for a remote service communication endpoint on a service bus. For example, modality handlers 110 may be configured to listen on a service bus for service request messages 106 for application functionality using a particular communication modality.

Embodiments may include functionality to generate code for generic delegates as subscribers that will receive service request messages 106 sent using a particular modality and invoke the corresponding service contract 112 methods. For each service contract method generated, a delegate is generated that is instantiated with that method's input parameters

When a message arrives via the routing module 108 or a service bus, an appropriate modality handler's instance is invoked. Its generated code creates an instance of the service contract and invokes the corresponding method passing deserialized message data as input parameters.

Thus, embodiments may implement automatic mapping of different communication protocol paradigms (such as communication schema and messages format) to a unified communication interface. In particular, embodiments include functionality for mapping various communication modalities to a service contracts' methods. A unified communication layer is implemented. The unified communication layer is implemented by including custom attributes that are used by developers for decorating a remote service main class with a service contract name and configuration parameters of communication modalities. The unified communication layer may include a unified communication component that is invoked within the remote service main class for automatic generation of code to create messaging handlers and subscribers that receive messages coming via corresponding communication modalities in push mode.

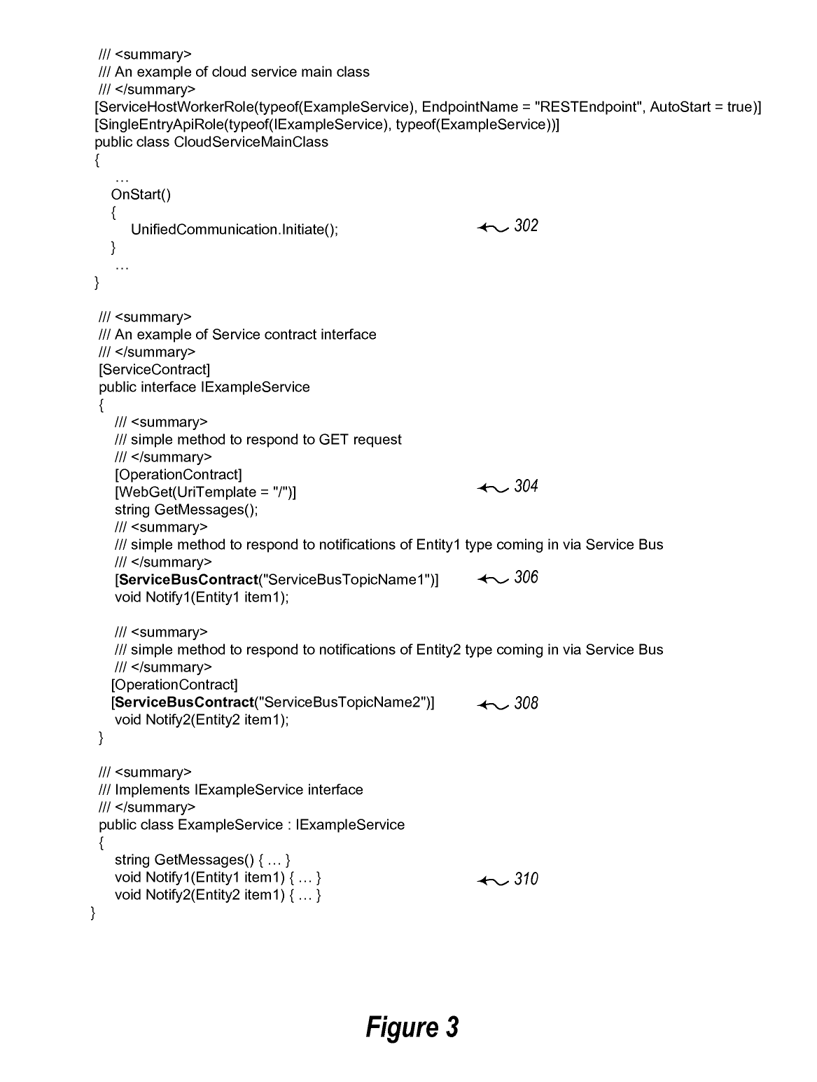

Referring now to FIG. 3, code is shown illustrating specific code annotation and decoration to illustrate elements of a unified communication component for a distributed service. FIG. 3 illustrates code 302 representing that invocation of the “Start” method of the remote service main class 114 invokes an “Initiate” method of the unified communication component 116. FIG. 3 illustrates code 304 representing decoration of a REST communication modality for an application function. FIG. 3 also illustrates code 306 representing decoration of a first Windows Azure® service bus communication modality for an application function. FIG. 3 illustrates code 308 representing decoration of a second Windows Azure® service bus communication modality for an application function. FIG. 3 illustrates code 310 representing code for invoking an interface for handling calls to application functionality through different modalities.

As a result of implementing the above code decorations, the unified communication component 116 may obtain signatures of service contract methods and check what methods are designed to receive notifications via Service Bus and what methods are designed to receive notifications via a REST communication channel. This may be done, for example, using .NET reflection.

Illustrating now a specific example, in accordance with decoration of service contract methods, the unified communication component 116 creates a service hosted in a cloud service and configures it to listen to the cloud service communication endpoints. The unified communication component 116 generates code of generic delegate as subscriber that will receive Service Bus messages and invoke the corresponding service contract methods. For each service contract method generated, a delegate is generated that is instantiated with a method's input parameters. When a message arrives via Service Bus, an appropriate delegate's instance is invoked; its generated code creates an instance of the service contract and invokes the corresponding method passing deserialized message data as input parameters.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

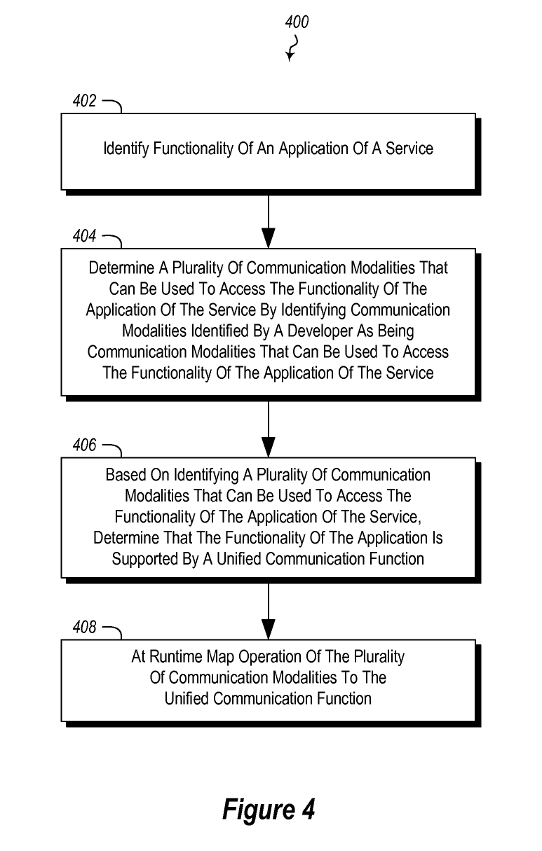

Referring now to FIG. 4, a method 400 is illustrated. The method 400 may be practiced in a distributed computing environment. For example, embodiments may be practiced where local clients access remote services that are logically or physically remote from the clients. As a further example, embodiments may be practiced in so called “cloud” computing system. The method 400 includes acts for implementing a unified communication system allowing different clients to communicate using different communication modalities to access the same functionality of a remote application. For example, different clients may be able to communicate with a remote application using different communication protocols or communication channels in attempts to access the same functionality of a remote application.

The method 400 includes identify functionality of an application of a service (act 402). For example, a method of a class may be identified. Identification may be done, such as for example, by using reflection of an application.

The method 400 further includes determining a plurality of communication modalities that can be used to access the functionality of the application of the service by identifying communication modalities identified by a developer as being communication modalities that can be used to access the functionality of the application of the service (act 404). For example, as illustrated in FIG. 3, methods can be annotated to show what communication modalities can be used to eventually call the methods. The method 400 may further include examining decorations or attributes applied to the functionality of the application to determine what communication modalities can be used to access the functionality of the application. The method 400 may further include examining declarative annotations to the functionality of the application to determine what communication modalities can be used to access the functionality of the application. FIG. 3 illustrates various decorations or attributes applied declaratively as annotations to methods of a class. The method 400 may further include using reflection to determine what communication modalities can be used to access the functionality of the application.

Based on identifying a plurality of communication modalities that can be used to access the functionality of the application of the service, the method 400 further includes determining that the functionality of the application is supported by a unified communication function (act 406). The unified communication function supports application functionality using different communication modalities.

The method 400 further includes, at runtime mapping operation of the plurality of communication modalities to the unified communication function (act 408). The method 400 may further include generating one or more generic delegates to map operation of the plurality of communication modalities to the unified communication function. When a message call arrives from a caller, the method 400 may include invoking a generic delegate appropriate for the message call to create an instance of a service contract to invoke the functionality of the application. For example, as illustrated in FIG. 1, an appropriate modality handler 110 may be called for a service request message 106 sent using a modality appropriate for a given modality handler 110. This can be used to invoke the service contract 112 to access the functionality of the application.

Embodiments may include functionality for sending messages back to client nodes using an appropriate modality as well. For example, the method 400 may further include receiving, from a caller, a message call to the functionality of the application using one or more of the plurality of communication modalities. The message call is translated to the unified communication function. The unified communication function and the translated message call are used to receive a result from the functionality of the application. The result is translated back to the one or more of the plurality of communication modalities. The translated result is sent back to the caller using the one or more of the plurality of communication modalities of the message call.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a distributed computing environment, a method of implementing a unified communication system allowing different clients to communicate using different communication modalities to access the same functionality of a remote application, the method comprising:
identifying functionality of an application of a service;
determining a plurality of communication modalities that can be used to access the functionality of the application of the service by identifying communication modalities identified by a developer as being communication modalities that can be used to access the functionality of the application of the service;
based on identifying a plurality of communication modalities that can be used to access the functionality of the application of the service, determining that the functionality of the application is supported by a unified communication function, wherein the unified communication function supports application functionality using different communication modalities; and
at runtime mapping operation of the plurality of communication modalities to the unified communication function.

2. The method of claim 1 further comprising:
receiving, from a caller, a message call to the functionality of the application using one or more of the plurality of communication modalities;
translating the message call to the unified communication function;
using the unified communication function and the translated message call to receive a result from the functionality of the application;
translating the result back to the one or more of the plurality of communication modalities; and
sending the translated result back to the caller using the one or more of the plurality of communication modalities of the message call.

3. The method of claim 1, further comprising examining decorations or attributes applied to the functionality of the application to determine what communication modalities can be used to access the functionality of the application.

4. The method of claim 1, further comprising examining declarative annotations to the functionality of the application to determine what communication modalities can be used to access the functionality of the application.

5. The method of claim 1, further comprising using reflection to determine what communication modalities can be used to access the functionality of the application.

6. The method of claim 1, further comprising generating one or more generic delegates to map operation of the plurality of communication modalities to the unified communication function.

7. The method of claim 6, further comprising, when a message call arrives from a caller, invoking a generic delegate appropriate for the message call to create an instance of a service contract to invoke the functionality of the application.

8. The method of claim 1, further comprising implementing methods of a class to implement the functionality of the application.

9. In a distributed computing environment, a system for implementing a unified communication system allowing different clients to communicate using different communication modalities to access the same functionality of a remote application, the system comprising
one or more processors; and
one or more computer readable media, wherein the one or more computer readable media comprise computer executable instructions that when executed by at least one of the one or more processors cause at least one of the one or more processors to perform the following:
identifying functionality of an application of a service;
determining a plurality of communication modalities that can be used to access the functionality of the application of the service by identifying communication modalities identified by a developer as being communication modalities that can be used to access the functionality of the application of the service;
based on identifying a plurality of communication modalities that can be used to access the functionality of the application of the service, determining that the functionality of the application is supported by a unified communication function, wherein the unified communication function supports application functionality using different communication modalities; and
at runtime mapping operation of the plurality of communication modalities to the unified communication function.

10. The system of claim 9, further comprising:
receiving, from a caller, a message call to the functionality of the application using one or more of the plurality of communication modalities;
translating the message call to the unified communication function;
using the unified communication function and the translated message call to receive a result from the functionality of the application;
translating the result back to the one or more of the plurality of communication modalities; and
sending the translated result back to the caller using the one or more of the plurality of communication modalities of the message call.

11. The system of claim 9, further comprising examining decorations or attributes applied to the functionality of the application to determine what communication modalities can be used to access the functionality of the application.

12. The system of claim 9, further comprising examining declarative annotations to the functionality of the application to determine what communication modalities can be used to access the functionality of the application.

13. The system of claim 9, further comprising using reflection to determine what communication modalities can be used to access the functionality of the application.

14. The system of claim 9, further comprising generating one or more generic delegates to map operation of the plurality of communication modalities to the unified communication function.

15. The system of claim 14, further comprising, when a message call arrives from a caller, invoking a generic delegate appropriate for the message call to create an instance of a service contract to invoke the functionality of the application.

16. The system of claim 9, further comprising implementing methods of a class to implement the functionality of the application.

17. In a distributed computing environment, a computer program product comprising a computer readable storage device, the computer readable storage device comprising computer executable instructions that when executed by one or more processors cause at least one of the one or more processors to perform the following:
identifying functionality of an application of a service;
determining a plurality of communication modalities that can be used to access the functionality of the application of the service by identifying communication modalities identified by a developer as being communication modalities that can be used to access the functionality of the application of the service by examining declarative annotations adding decorations or attributes applied to the functionality;
based on identifying a plurality of communication modalities that can be used to access the functionality of the application of the service, determining that the functionality of the application is supported by a unified communication function, wherein the unified communication function supports application functionality using different communication modalities; and
at runtime mapping operation of the plurality of communication modalities to the unified communication function.

18. The computer program product of claim 17, further comprising:
receiving, from a caller, a message call to the functionality of the application using one or more of the plurality of communication modalities;
translating the message call to the unified communication function;
using the unified communication function and the translated message call to receive a result from the functionality of the application;
translating the result back to the one or more of the plurality of communication modalities; and
sending the translated result back to the caller using the one or more of the plurality of communication modalities of the message call.

19. The computer program product of claim 17, further comprising generating one or more generic delegates to map operation of the plurality of communication modalities to the unified communication function.

20. The computer program product of claim 19, further comprising, when a message call arrives from a caller, invoking a generic delegate appropriate for the message call to create an instance of a service contract to invoke the functionality of the application.
